(19) United States
(12) Patent Application Publication
(10) Pub. No.: US 2026/0177240 A1
(43) Pub. Date: Jun. 25, 2026

(54) STEREOSCOPIC ARCH IGNITOR RESISTOR AND MANUFACTURING METHOD THEREOF

(71) Applicant: VIKING TECH CORPORATION, Hsinchu County (TW)

(72) Inventors: CHIAO-HSIN CHANG, Hsinchu County (TW); SHUN-HO KUO, Hsinchu County (TW); CHI-YU LU, Hsinchu County (TW)

(21) Appl. No.: 18/988,092

(22) Filed: Dec. 19, 2024

(51) Int. Cl. F23Q 7/02; H01C 1/01; H01C 13/00; H01C 17/00; H05B 3/06

(52) U.S. Cl. CPC F23Q 7/02; H01C 1/01; H01C 13/00; H01C 17/00; H05B 3/06; H05B 2203/017

(57) ABSTRACT

A stereoscopic arch ignitor resistor and manufacturing method thereof are provided. The stereoscopic arch ignitor resistor includes a substrate, an alloy layer, a combustible material accommodating portion, and a lateral conductive layer. The alloy layer is disposed on a first surface of the substrate. The alloy layer includes an arch lead, a first connecting portion, and a second connecting portion. The combustible material accommodating portion is positioned between the arched lead and the substrate. The arch lead defines a volume of combustible material of the combustible material accommodating portion. The lateral conductive layer is disposed on the alloy layer. The lateral conductive layer abuts against a side surface of the substrate. The stereoscopic arch-type ignition resistance element is configured to reduce ignition distance and/or increase contact area with combustible material.

### BACKGROUND OF THE INVENTION

### 1. Field of the Invention

The present disclosure relates to the technical field of ignitor resistor, and in particular to the stereoscopic arch ignitor resistor and manufacturing method thereof.

### 2. Description of the Prior Art

When current flows through the ignitor resistor, the electrical energy is converted into thermal energy by the Joule effect, which conducts the heat energy to the combustible material through thermal conduction, so that the temperature reaches the ignition point for combustion; or, the ignitor resistor generates sparks by melting and breaking the lead under the high temperature to ignite the surrounding combustible material.

However, the traditional bridgewire ignitor resistor only has a small contact area between the bridgewire and the combustible material, which requires a long ignition response time and a high ignition voltage, and has a limited range of heat conduction, resulting in uneven heating of the combustible material, i.e., only the portion of the combustible material closed to the bridgewire has higher temperature and cannot quickly ignite all the combustible material. In addition, the bridgewires of traditional ignitor resistors are usually improper welded, resulting in false welding and failure to ignite properly. Moreover, the wire diameter of the bridgewires of the ignition portion of traditional bridgewire ignitor resistors are small. The bridgewires are prone to breaking after loading components or during transportation and causes ignition failure problem. Therefore, it is difficult to ensure the stability and ignition accuracy of traditional ignitor resistor.

### SUMMARY OF THE INVENTION

In view of the foregoing, the present disclosure provides A stereoscopic arch ignitor resistor, including the following:
a substrate;
an alloy layer disposed on a first surface of the substrate, in which the alloy layer includes an arched lead, a first connecting portion, and a second connecting portion, the arched lead is positioned between the first connecting portion and the second connecting portion;
a combustible material accommodating portion positioned between the arched lead and the substrate, the arched lead defines a volume of a combustible material in the combustible material accommodating portion; and
a lateral conductive layer disposed on the alloy layer, and the lateral conductive layer abuts against a side surface of the substrate;
in which the stereoscopic arch ignitor resistor is configured to reduce ignition distance and/or increase contact area with combustible material.

Preferably, an eccentricity of the arch-shaped lead is ε, where 0<ε<1.

Preferably, the stereoscopic arch ignitor resistor further includes a back electrode layer, in which the back electrode layer is disposed on a second surface of the substrate, and the lateral conductive layer abuts against the alloy layer, the substrate, and the back electrode layer.

Preferably, a length of the arch-shaped lead is greater than a distance between the first connecting portion and the second connecting portion, and the arch-shaped lead is configured to reduce ignition response time.

Preferably, a diameter of the arched lead is 50-250 μm.

Furthermore, the present disclosure provides a manufacturing method of a stereoscopic arch ignitor resistor, including the following:
disposing an alloy layer on a first surface of a substrate, etching the alloy layer to form an arched lead, a first connecting portion, and a second connecting portion, in which the arched lead is positioned between the first connecting portion and the third connecting portion, the arched lead and the substrate define a volume of a combustible material in the combustible material accommodating portion; and
disposing a lateral conductive layer on the alloy layer, in which the lateral conductive layer abuts against a side surface of the substrate;
in which the stereoscopic arch ignitor resistor is configured to reduce ignition distance and/or increase contact area with combustible material.

Preferably, an eccentricity of the arched lead is ε, where 0<ε<1.

Preferably, the manufacturing method further including: disposing a back electrode layer on a second surface of the substrate, in which the lateral conductive layer abuts against the alloy layer, the substrate, and the back electrode layer.

Preferably, a length of the arch-shaped lead is greater than a distance between the first connecting portion and the second connecting portion, and the arch-shaped lead is configured to increase a contact area with the combustible material.

Preferably, a diameter of the arched lead is 50-250 μm.

The stereoscopic arch ignitor resistor of the present disclosure defines a combustible material accommodation portion for the combustible material by an arched lead. The combustible material covers the entity of arched lead, which not only increases the contact surface between the stereoscopic arch ignitor resistor and the combustible material, but also increases the volume of the combustible material accommodated by the stereoscopic arch ignitor resistor. Therefore, when the stereoscopic arch ignitor resistor is energized, the combustible material can be heated evenly, thereby reducing the ignition response time and ignition distance, increasing the contact area with the combustible material, increasing safe operating voltage, and enhancing the stability, ignition accuracy, and transportation safety of the stereoscopic arch ignitor resistor.

### BRIEF DESCRIPTION OF THE DRAWINGS

FIG. 1 is a flow chart of the manufacturing method of the stereoscopic arch ignitor resistor of the present disclosure.

FIG. 2 is a cross-sectional view of the stereoscopic arch ignitor resistor of the present disclosure.

FIGS. 3-8 are schematic diagrams of the manufacturing method of the stereoscopic arch ignitor resistor of the present disclosure.

FIG. 9 is a top view of the first embodiment of the stereoscopic arch ignitor resistor of the present disclosure.

FIG. 10 is a top view of the second embodiment of the stereoscopic arch ignitor resistor of the present disclosure.

### DESCRIPTION OF THE PREFERRED EMBODIMENTS

The following embodiments, together with the drawings, are used to illustrate the spirit of the present disclosure, so that those with ordinary knowledge in the field to which the present disclosure belongs can clearly understand the technology of the present disclosure, but are not intended to limit the scope of the present disclosure. It is appreciated that the drawings are for illustrative purposes only and do not represent the actual size or quantity of components. Some details may not be fully drawn to keep the drawings concise.

For simplicity of explanation, a rectangular stereoscopic arch ignitor resistor is taken as an example. However, it is appreciated that it is used as an example and does not intend to limit the present disclosure. The stereoscopic arch ignitor resistor of the present disclosure can be implemented in any shape.

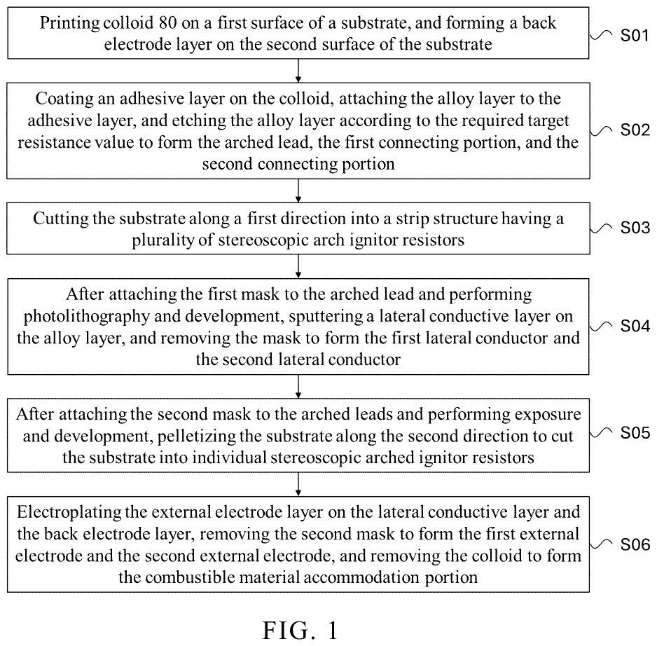

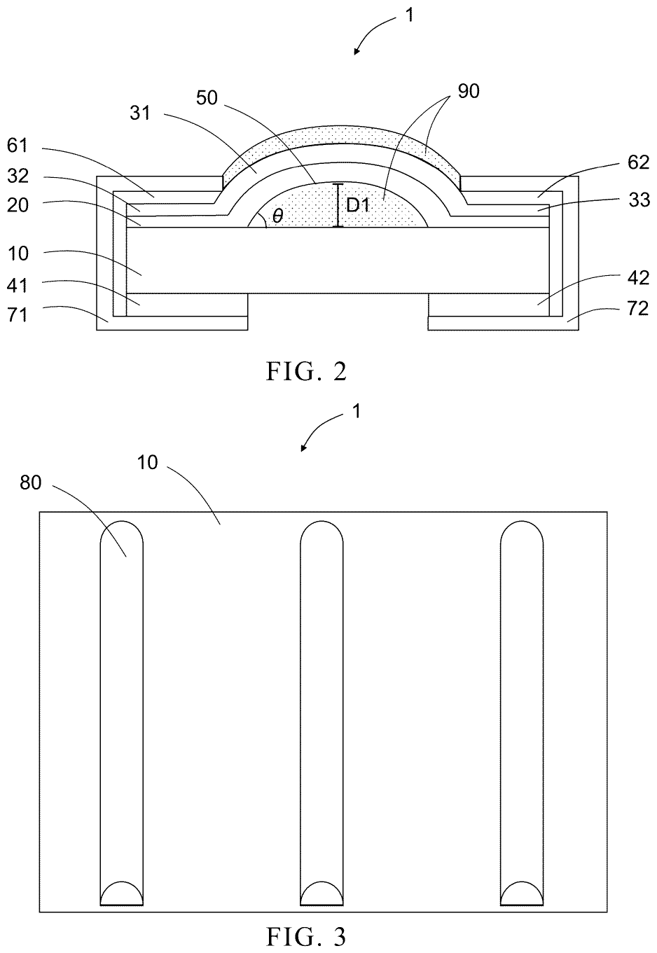

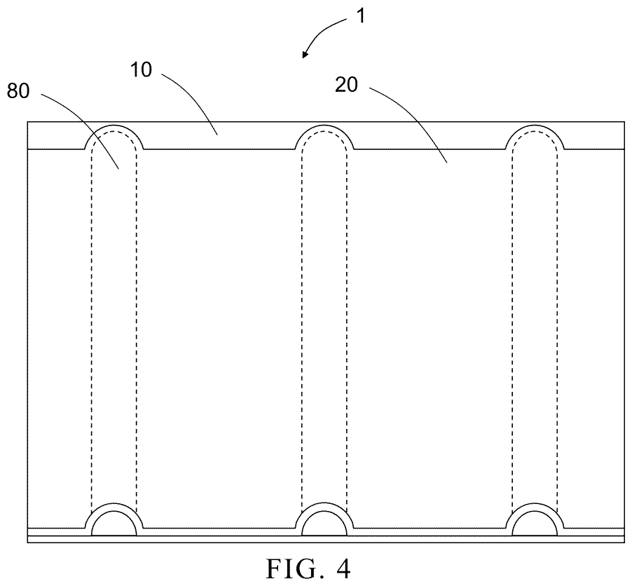

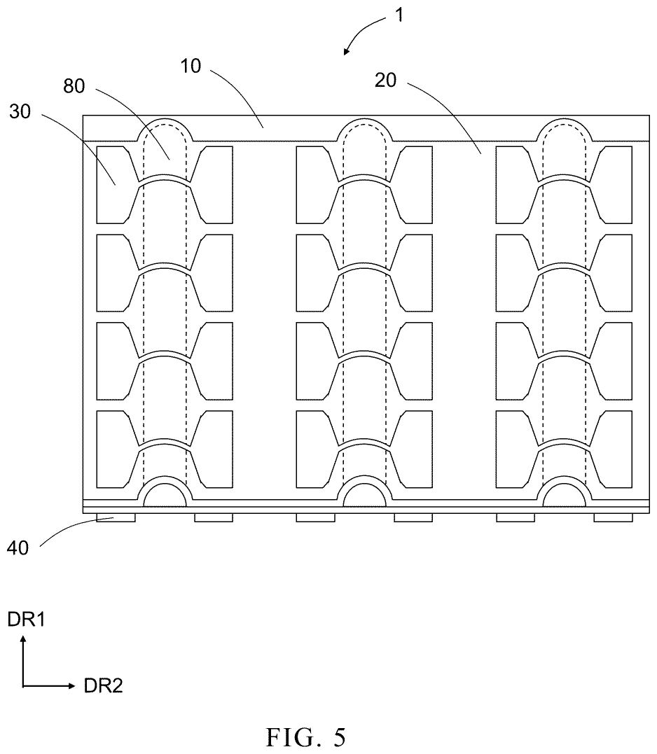

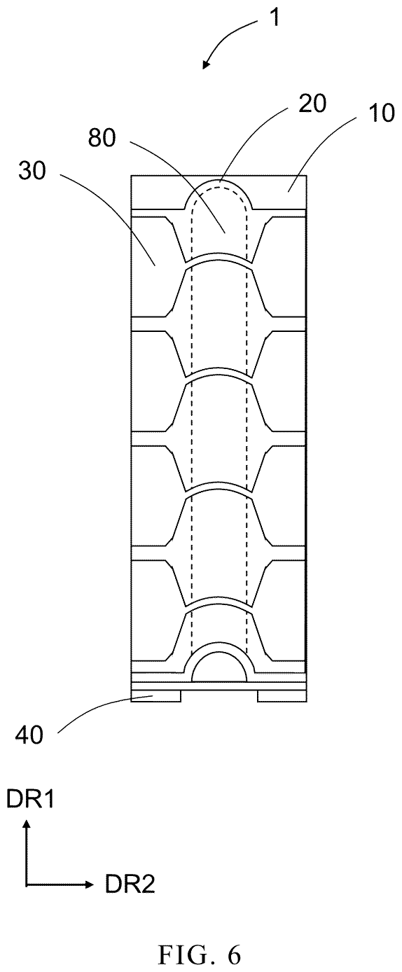

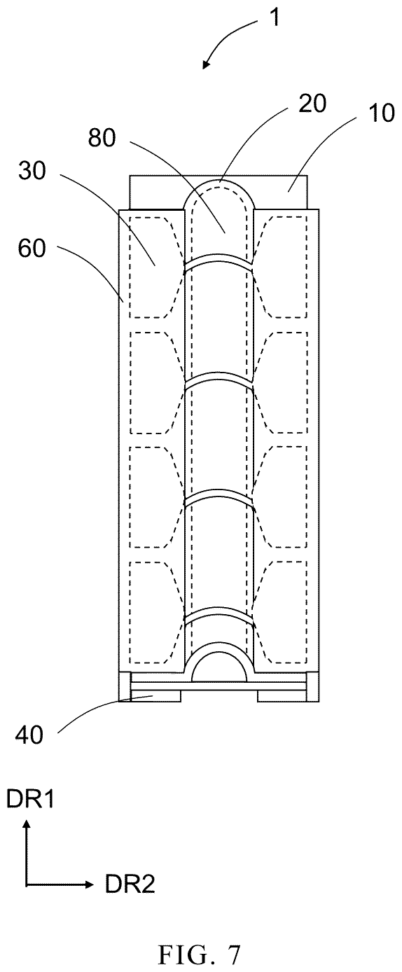

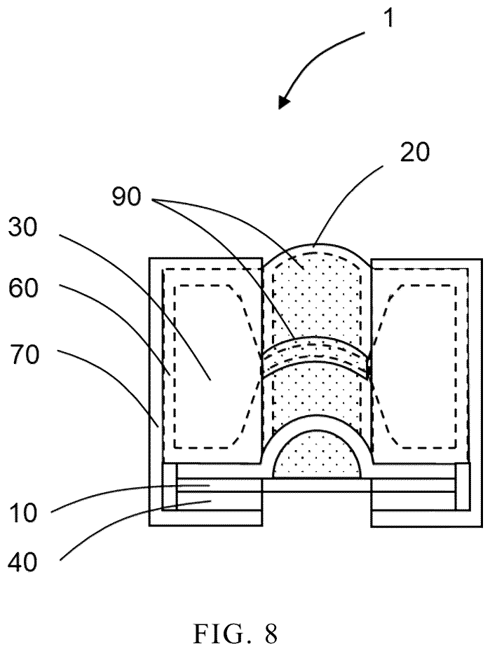

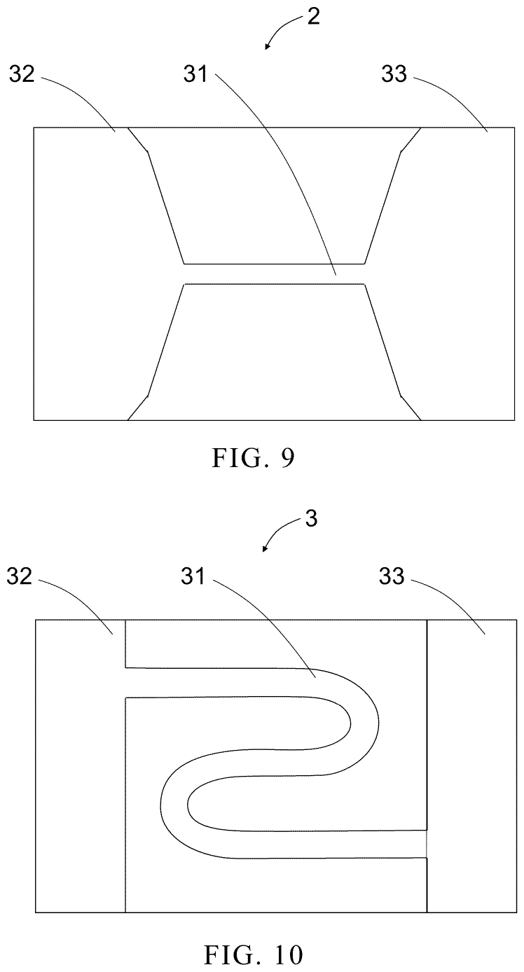

Please refer to FIGS. 1-10. FIG. 1 is a flow chart of the manufacturing method of the stereoscopic arch ignitor resistor of the present disclosure. FIG. 2 is a cross-sectional view of the stereoscopic arch ignitor resistor of the present disclosure. FIGS. 3-8 are schematic diagrams of the manufacturing method of the stereoscopic arch ignitor resistor of the present disclosure. FIG. 9 is a top view of the first embodiment of the stereoscopic arch ignitor resistor of the present disclosure. FIG. 10 is a top view of the second embodiment of the stereoscopic arch ignitor resistor of the present disclosure.

The stereoscopic arch ignitor resistor 1-3 of the present disclosure is provided with a substrate 10, an adhesive layer 20, an alloy layer 30, a back electrode layer 40, a lateral conductive layer 60, and an external electrode layer 70.

The manufacturing method of the stereoscopic arch ignitor resistor 1-3 of the present disclosure is as follows:

Step S01: Printing colloid 80 on a first surface of a substrate 10, and forming a back electrode layer 40 on the second surface of the substrate 10. The back electrode layer 40 can be formed by sputtering, electroplating, or printing. The colloid 80 and the back electrode layer 40 are both strip-shaped structures parallel to each other. The back electrode layer 40 further includes a first back electrode 41 and a second back electrode 42.

The material of the substrate 10 may be an FR4 glass fiber substrate or a ceramic substrate. The material of the colloid 80 is a polymer, such as an acrylic polymer. The material of the back electrode layer 40 is metal, such as copper and silver.

Step S02: Coating an adhesive layer 20 on the colloid 80, attaching the alloy layer 30 to the adhesive layer 20, and etching the alloy layer 30 according to the required target resistance value to form the arched lead 31, the first connecting portion 32, and the second connecting portion 33. The arched lead 31 is positioned between the first connecting portion 32 and the second connecting portion 33. The first connecting portion 32 is disposed relative to the first back electrode 41. The second connecting portion 33 is disposed relative to the second back electrode 42.

The upper arch angle θ of the arched lead 31 is 0°<θ<90°. For every 1 degree increase in the upper arch angle θ, the ignition distance increases by 2%-5%, preferably 3.3%, the contact area between the arched lead 31 and the combustible material 90 increases by 1%-5%, preferably 1.5%-2%, and the ignition response time reduces by 1%-5%. The semi-major axe of the arched lead 31 (i.e. half of the distance between the first connecting portion 32 and the second connecting portion 33) is greater than the semi-minor axe (i.e. the upper arch distance D1), so that the eccentricity of the arched lead 31 is ε, where 0<ε<1. The length of the arched lead is greater than the distance between the first connecting portion 32 and the second connecting portion 33. The upper arch distance D1 of the arched lead 31 is 0.2-1.1 mm, preferably 0.4-1.08 mm. The upper arch distance D1 of the arch lead 31 can reduce the ignition distance with the surrounding combustible material to 0.4-1.08 mm. The wire diameter of the arched lead 31 is 50-250 μm, thereby increasing the contact area between the arched lead 31 and the combustible material 90, increasing the safe operating voltage and enhancing the transportation safety of the stereoscopic arch ignitor resistor 1-3.

The material of the combustible material 90 is gunpowder. Examples of the gunpowder include ZPP, PETN, KDNBF, etc.

As shown in FIG. 9 and FIG. 10, the arch lead 31 may be a bridge lead or an S-shaped lead.

The material of the adhesive layer 20 is polymer, such as epoxy resin adhesive. The material of the alloy layer 30 is nickel-chromium alloy (NiCr).

Step S03: Cutting the substrate 10 along a first direction DR1 into a strip structure having a plurality of stereoscopic arch ignitor resistors.

Step S04: After attaching the first mask to the arched lead 31 and performing photolithography and development, sputtering a lateral conductive layer 60 on the alloy layer 30, and removing the mask to form the first lateral conductor 61 and the second lateral conductor 62. The first lateral conductor 61 is disposed with respect to the first connecting portion 32, and abuts against the side surfaces of the first connecting portion 32, the adhesive layer 20, the substrate 10, and the first back electrode 41. The second lateral conductor 62 is disposed with respect to the second connecting portion 33, and abuts against the side surfaces of the second connecting portion 33, the adhesive layer 20, the substrate 10, and the second back electrode 42. The material of the lateral conductive layer 60 is nickel-chromium alloy (NiCr), copper (Cu), or nickel (Ni). The lateral conductive layer 60 facilitates to distribute current evenly and avoids localized overheating or excessive stress, thus improving the reliability of the resistor.

Step S05: After attaching the second mask to the arched leads 31 and performing exposure and development, pelletizing the substrate 10 along the second direction DR2 to cut the substrate 10 into individual stereoscopic arched ignitor resistors. The first mask and the second mask may be the same or different masks.

Step S06: Electroplating the external electrode layer 70 on the lateral conductive layer and the back electrode layer 40, removing the second mask to form the first external electrode 71 and the second external electrode 72, and removing the colloid 80 to form the combustible material accommodation portion 50. The first external electrode 71 abuts against the first side electrode layer and the first back electrode layer 41, and the second external electrode 72 abuts against and covers the second side electrode layer and the second back electrode layer 42, thereby shortening the conductive path, reducing the generation of inductance, crosstalk, and noise, and protecting each component layer from sulfur gas and water vapor intrusion. The outer electrode layer 70 is made of a nickel-tin composite metal layer.

The printing, coating, sputtering, exposure, development, electroplating, and other processes used in the present disclosure can be performed using conventional techniques to achieve the same effect. For the sake of simplicity, the present disclosure will not describe them redundantly.

The stereoscopic arch ignitor resistor of the present disclosure defines a combustible material accommodation portion for the combustible material by an arched lead. The combustible material covers the entity of arched lead, which not only increases the contact surface between the stereoscopic arch ignitor resistor and the combustible material, but also increases the volume of combustible material accommodated by the stereoscopic arch ignitor resistor. Therefore, when the stereoscopic arch ignitor resistor is energized, the combustible material can be heated evenly, thereby reducing the ignition response time, and ignition distance, increasing the contact area with the combustible material, increasing safe operating voltage, and enhancing the stability, ignition accuracy, and transportation safety of the stereoscopic arch ignitor resistor.

What is claimed is:

1. A stereoscopic arch ignitor resistor, comprising:
a substrate;
an alloy layer disposed on a first surface of the substrate, wherein the alloy layer comprises an arched lead, a first connecting portion, and a second connecting portion, the arched lead is positioned between the first connecting portion and the second connecting portion;
a combustible material accommodating portion positioned between the arched lead and the substrate, the arched lead defines a volume of a combustible material in the combustible material accommodating portion; and
a lateral conductive layer disposed on the alloy layer, and the lateral conductive layer abuts against a side surface of the substrate;
wherein the stereoscopic arch ignitor resistor is configured to reduce an ignition distance and/or increase a contact area with the combustible material.

2. The stereoscopic arch ignitor resistor according to claim 1, wherein an eccentricity of the arch-shaped lead is ε, where 0<ε<1.

3. The stereoscopic arch ignitor resistor according to claim 1, further comprising: a back electrode layer, wherein the back electrode layer is disposed on a second surface of the substrate, and the lateral conductive layer abuts against the alloy layer, the substrate, and the back electrode layer.

4. The stereoscopic arch ignitor resistor according to claim 1, wherein a length of the arch-shaped lead is greater than a distance between the first connecting portion and the second connecting portion, and the arch-shaped lead is configured to reduce ignition response time.

5. The stereoscopic arch ignitor resistor according to claim 1, wherein a diameter of the arched lead is 50-250 μm.

6. A manufacturing method of a stereoscopic arch ignitor resistor, comprising:
disposing an alloy layer on a first surface of a substrate, etching the alloy layer to form an arched lead, a first connecting portion, and a second connecting portion, wherein the arched lead is positioned between the first connecting portion and the third connecting portion, the arched lead and the substrate define a volume of a combustible material in the combustible material accommodating portion; and
disposing a lateral conductive layer on the alloy layer, wherein the lateral conductive layer abuts against a side surface of the substrate;
wherein the stereoscopic arch ignitor resistor is configured to reduce ignition distance and/or increase a contact area with the combustible material.

7. The manufacturing method according to claim 6, wherein an eccentricity of the arched lead is ε, where 0<ε<1.

8. The manufacturing method according to claim 6, further comprising: disposing a back electrode layer on a second surface of the substrate, wherein the lateral conductive layer abuts against the alloy layer, the substrate, and the back electrode layer.

9. The manufacturing method according to claim 6, wherein a length of the arch-shaped lead is greater than a distance between the first connecting portion and the second connecting portion, and the arch-shaped lead is configured to reduce ignition response time.

10. The manufacturing method according to claim 6, wherein a diameter of the arched lead is 50-250 μm.
